(19) United States
(12) Patent Application Publication
(10) Pub. No.: US 2003/0179051 A1
(43) Pub. Date: Sep. 25, 2003

(54) Low-temperature high-frequency amplifying apparatus and wireless apparatus

(76) Inventors: Jun Hattori, Takatsuki-shi (JP); Norifumi Matsui, Kyoto-shi (JP)

Correspondence Address: DICKSTEIN SHAPIRO MORIN & OSHINSKY LLP, Richard LaCava, 41st Floor, 1177 Avenue of the Americas, New York, NY, 10036-2714, US

(21) Appl. No.: 10/389,564

(22) Filed: Mar. 17, 2003

(30) Foreign Application Priority Data
Mar. 20, 2002 (JP) 2002-078292

(51) Int. Cl. H01P 1/20; H01B 12/02

(52) U.S. Cl. 333/99 S; 505/210

(57) ABSTRACT

A low temperature high-frequency amplifying apparatus which includes an amplifying circuit and a cold stage for cooling the amplifying circuit. The amplifying circuit and the cold stage are accommodated in a thermally insulated container. An input connector of the thermally insulated container, which is exposed to the outside, is connected with an input portion of the amplifying circuit via an input cable, and an output portion of the amplifier is connected with an output connector of the thermally insulated container via an output cable. The signal transmission loss of the input cable is lower than the signal transmission loss of the output cable, and the amount of heat penetration from the output cable is less than the amount of heat penetration from the input cable.

### BACKGROUND OF THE INVENTION

1. Field of the Invention

The present invention relates to a low-temperature high-frequency amplifying apparatus in which a high-frequency amplifier operates at low temperature.

2. Description of the Related Art

In the related art, an extremely low-noise amplifier is required immediately after a receiver (antenna) of a receiving apparatus for receiving extremely weak waves in, for example, mobile communications, satellite communications, and so on. In general, one effective method of reducing the noise level of an amplifier is to cool the amplifier itself. Japanese Unexamined Patent Application Publication No. 61-48201 discloses a low-noise amplifier system which includes a waveguide having a cutoff portion, an amplifier disposed in the cutoff portion, and a cooling device capable of directly cooling the amplifier.

It is also effective to dispose a high-frequency circuit within a thermostatic bath in order to maintain the ambient temperature for stable operation of a high-frequency circuit or in order to operate the circuit superconductively for low-loss operation of the circuit. Japanese Unexamined Patent Application Publication No. 9-129041 discloses an apparatus for transmitting signals between a high-frequency circuit disposed in a thermostatic bath and an external device via a thermally insulated coaxial cable.

Since such a cable with low heat penetration is designed primarily with high thermal insulation, the electrical transmission loss is not necessarily low and the signal transmission loss is greater than that of typical cables. That cable is therefore disadvantageous in view of the NF (Noise Figure) of the high-frequency amplifying circuit. Typically, high-frequency cables provide low thermal insulation, resulting in high heat penetration from the outside to the circuit disposed in the thermostatic bath. This causes an unstable operation of the circuit in the thermostatic bath or requires a cooling device with better cooling capability to deal with the high heat penetration. That is, the reduction in heat penetration and the reduction in transmission loss are not compatible.

The transmission loss and the cable length are substantially proportional, and the amount of heat penetration and the cable length are substantially inversely proportional. The apparatuses disclosed in the above-noted publications are not designed to effectively achieve both a reduction in heat penetration and a reduction in transmission loss, but are designed to sacrifice either the reduction in transmission loss or heat penetration when the input and output sides have equal cable length.

### SUMMARY OF THE INVENTION

Accordingly, it is an object of the present invention to provide a low-temperature high-frequency amplifying apparatus in which both heat penetration and transmission loss are reduced in order to reduce the NF, and a wireless apparatus including this amplifying apparatus.

In one aspect of the present invention, a low-temperature high-frequency amplifying apparatus includes an amplifying circuit, a cooling unit for cooling the amplifying circuit, and a thermally insulated container which accommodates at least the amplifying circuit and the cooling unit. The thermally insulated container has an input connector exposed to the outside, and the input connector is connected with an input portion of the amplifying circuit via an input high-frequency line. The thermally insulated container has an output connector exposed to the outside, and the output connector is connected with an output portion of the amplifying circuit via an output high-frequency line. The signal transmission loss of the input high-frequency line is lower than the signal transmission loss of the output high-frequency line, and the amount of heat penetration from the output high-frequency line to the amplifying circuit is less than the amount of heat penetration from the input high-frequency line to the amplifying circuit. Therefore, the NF is improved without reduction in cooling efficiency of the overall apparatus, thus achieving a compact low-temperature high-frequency amplifying apparatus with low power consumption and better electrical properties.

In the low-temperature high-frequency amplifying apparatus of the present invention, preferably, the input high-frequency line is shorter than the output high-frequency line. Since cables having the same shape can be used for both the input high-frequency line and the output high-frequency line, the input and output portions of the amplifier have the same structure for connecting to the coaxial cables. In addition, both the input and output connectors of the thermally insulated container which are exposed to the outside have the same shape, thus reducing the cost.

In the low-temperature high-frequency amplifying apparatus of the present invention, preferably, the distance from the input portion of the amplifying circuit to a wall of the thermally insulated container is substantially equal to the distance from the output portion of the amplifying circuit to the wall of the thermally insulated container, and the line length of the input high-frequency line is reduced compared to the line length of the output high frequency line.

This enables the amplifying circuit to be placed at the center in the thermally insulated container, while reducing the transmission loss of the input cable to a minimum, thus effectively improving the NF and the cooling efficiency.

In the low-temperature high-frequency amplifying apparatus of the present invention, preferably, the input high-frequency line has a greater cross-sectional area than the output high-frequency line. It is therefore unnecessary to place the output high-frequency line in a complex manner around in the thermally insulated container, resulting in a simple arrangement of the high-frequency lines in the thermally insulated container.

In the low-temperature high-frequency amplifying apparatus of the present invention, the amplifying circuit may include an amplifier and a high-frequency filter which is connected to the input side of the amplifier. Therefore, a distortion due to an undesired frequency band signal can be suppressed, thus improving the NF.

In the low-temperature high-frequency amplifying apparatus of the present invention, preferably, the high-frequency filter comprises a superconductive filter having an electrode made of a superconductor. Therefore, an insertion loss caused by the filter can be greatly reduced, thus improving the NF.

In another aspect of the present invention, a wireless apparatus includes an amplifying stage for amplifying a high-frequency signal, and the amplifying stage includes the low temperature high-frequency amplifying apparatus having any structure mentioned above. A wireless apparatus which uses a compact low-temperature high-frequency amplifying apparatus having high cooling efficiency and low NF is suitable for reception of weak waves and wireless communication with low error code rate and high data transmission rate.

### BRIEF DESCRIPTION OF THE DRAWINGS

FIG. 1 is a schematic view of a low-temperature high-frequency amplifying apparatus according to a first embodiment of the present invention;

FIG. 2 is a cross-sectional view of an input or output cable of the low-temperature high-frequency amplifying apparatus;

FIGS., 3A through 3C are graphs showing a relationship between the ratio of the input cable length to the output cable length and various characteristic values;

FIG. 4 is a schematic view of a second embodiment of the low-temperature high-frequency amplifying apparatus;

FIG. 5 is a schematic view of a low-temperature high-frequency amplifying apparatus according to a third embodiment of the present invention; and

FIG. 6 is a block diagram of a wireless apparatus according to an aspect of the present invention.

### DESCRIPTION OF THE PREFERRED EMBODIMENTS

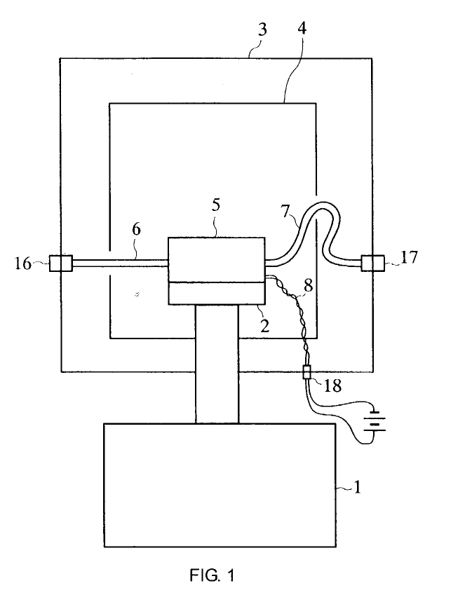

The structure of a low-temperature high-frequency amplifying apparatus according to a first embodiment of the present invention is described below with reference to FIGS. 1 through 4.

FIG. 1 is a schematic view of the low-temperature high-frequency amplifying apparatus. A cooling device 1 cools a cold stage 2. An amplifier 5 is mounted on the cold stage 2. A radiation shield 4 surrounds the amplifier 5. The radiation shield 4 is accommodated in a vacuum thermally insulated container 3. one example of the vacuum thermally insulated container is a simple vacuum case. The thermally insulated container 3 has an input connector 16 and an output connector 17. An input portion of the amplifier 5 is connected with the input connector 16 via an input cable 6. An output portion of the amplifier 5 is connected with the output connector 17 via an output cable 7. The thermally insulated container 3 also has a power supply connector 18. The power supply connector 18 is connected with the amplifier 5 via a power supply cable 8.

In FIG. 1, the cooling device 1 is a cooling device such as a Stirling refrigerator, a GM refrigerator, a pulse tube refrigerator, or a Peltier cooler.

The input cable 6 and the output cable 7 are, for example, coaxial cables, and are preferably thermally insulated coaxial cables having low thermal conductivity and low transmission loss.

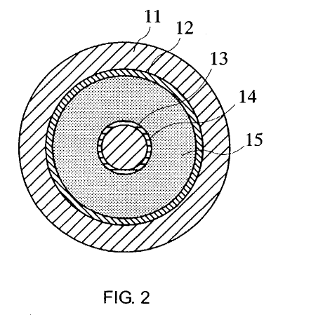

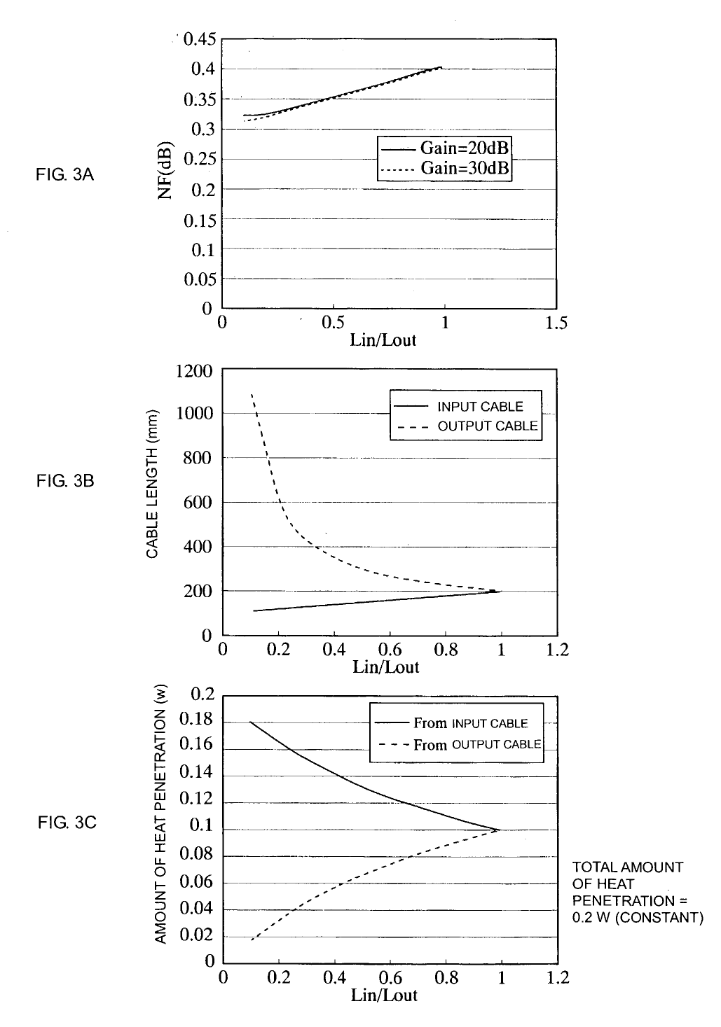

FIG. 2 is a cross-sectional view of a thermally insulated coaxial cable used for the input cable 6 and the output cable 7. An outer conductor 11 is made of low-thermal-conductivity metal such as stainless steel or cupronickel. An inner wall 12 of the outer conductor 11 is formed of a high-conductivity metal film such as a silver or copper film. The thickness of the metal film is, for example, 1 to 10 [symbol] m. An inner conductor 13 is made of low-thermal-conductivity metal. An outer wall 14 of the inner conductor 13 is formed of a high-conductivity metal film. A space defined between the outer wall 14 of the inner conductor 13 and the inner wall 12 of the outer conductor 11 is filled with an insulator 15 made of low-thermal-conductivity material such as PTFE (polytetrafluoroethylene).

Thus, each of the input cable 6 and the output cable 7 has low thermal conductivity per cross-sectional area of the overall cable, resulting in low heat penetration from the outside of the thermally insulated container 3 to the amplifier 5 shown in FIG. 1.

FIGS. 3A through 3C are graphs showing a relationship between the ratio of the input cable length to the output cable length and various characteristic values. In FIGS. 3A through 3C, the total amount of heat penetration from the input cable 6 and the output cable 7 is maintained constant (0.2 W). In FIGS. 3A through 3C, Lin indicates the length of the input cable 6, and Lout indicates the length of the output cable 7. The x-axis represents the ratio of Lin to Lout. It is assumed herein that the cable loss is 1 dB/m and the amplifier NF is 0.2 dB.

FIG. 3A depicts the NF (Noise Figure) of the input cable 6, the output cable 7, and the amplifier 5 versus the Lin-to-Lout ratio. In FIG. 3A, the solid line indicates the characteristic when the amplification factor of the amplifier 5 is 20 dB, and the broken line indicates the characteristic when the amplification factor of the amplifier 5 is 30 dB. In view of signal amplification, it is desirable to reduce the cable loss as much as possible. However, since the signal amplified by and output from the amplifier 5 has high signal strength, the loss of the output cable 7 is not as important as the loss of the input cable 6. Thus, as depicted in FIG. 3A, the NF can be reduced as the Lin-to-Lout ratio decreases.

FIG. 3B depicts the cable length versus the Lin-to-Lout ratio. As depicted in FIG. 3B, in order to reduce the Lin-to-Lout ratio, the input cable 6 should be short while the output cable 7 should be long.

FIG. 3C depicts the amount of heat penetration versus the Lin-to-Lout ratio. As depicted in FIG. 3C, in order to reduce the Lin-to-Lout ratio, the amount of heat penetration from the output cable 7 should decrease while the amount of heat penetration from the input cable 6 increases, i.e., the reduction in heat penetration from the input cable 6 is sacrificed.

Using the above-described characteristics, the input cable 6 is made shorter than the output cable 7 while the input and output cables 6 and 7 have the same cross-section shape and dimensions. The distance from the input portion of the amplifier 5 to the wall of the thermally insulated container 3 is preferably set to be substantially equal to the distance from the output portion of the amplifier 5 to the wall of the thermally insulated container 3. Thus, high cooling efficiency is maintained. In addition, the line length of the input cable 6 is preferably reduced, thereby reducing the transmission loss of the input cable 6 as much as possible.

As is apparent from the characteristics depicted in FIGS. 3A through 3C, the signal transmission loss of the input cable should be smaller than the signal transmission loss of the output cable, and the amount of heat penetration from the output cable to the amplifier should be smaller than the amount of heat penetration from the input cable to the amplifier.

The above characteristics may also be achieved by an input cable 6 and an output cable 7 having an equal cable length, with the input cable 6 having a greater cross-sectional area than that of the output cable 7.

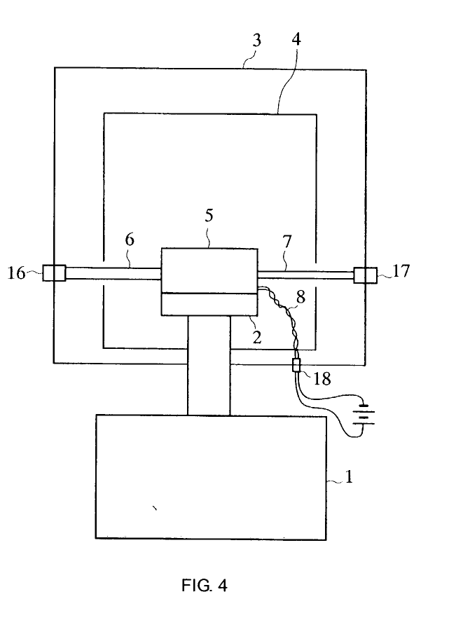

The low-temperature high-frequency amplifying apparatus having such a structure is shown in the second embodiment of FIG. 4. In this example, the input cable 6 and the output cable 7 are thermally insulated coaxial cables. The input cable 6 employs a thermally insulated coaxial cable having a greater cross-sectional area than that of the output cable 7. In FIG. 4, the distance from the input portion of the amplifier 5 to the wall of the thermally insulated container 3 is substantially equal to the distance from the output portion of the amplifier 5 to the wall of the thermally insulated container 3. This enables the amplifier 5 to be placed at the center in the thermally insulated container 3, while reducing the transmission loss of the input cable 6 to a minimum, thus effectively improving the NF and the cooling efficiency.

The structures of amplifying apparatus shown in FIG. 1 and the amplifying apparatus shown in FIG. 4 may be combined. Specifically, the output cable 7 may be longer than the input cable 6, and the cross-sectional area of the output cable 7 may be smaller than that of the input cable 6.

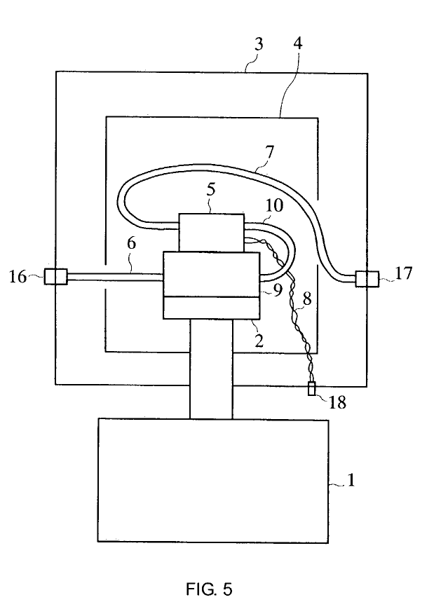

The structure of a low-temperature high-frequency amplifying apparatus according to a third embodiment of the present invention is described below with reference to FIG. 5.

In the low-temperature high-frequency amplifying apparatus according to the first embodiment, only the amplifier 5 is mounted on the cold stage 2. However, in the low-temperature high-frequency amplifying apparatus shown in FIG. 5, both the amplifier 5 and a high-frequency filter 9 are mounted on the cold stage 2. The high-frequency filter 9 is preferably connected to the input side of the amplifier 5. An input portion of the high-frequency filter 9 is connected with the input connector 16 via the input cable 6. The high-frequency filter 9 is a dielectric filter having a dielectric material and an electrode film formed on both the inner and outer surfaces of the dielectric material, and the electrode film is a superconductive film. Thus, the conductor loss can be greatly reduced, and a low insertion loss characteristic can be achieved. Therefore, it is effective to cool the superconductive filter 9 to the critical temperature of the superconductive film or lower.

Since an amplifying circuit formed of the high-frequency filter 9 and the amplifier 5 exhibits characteristics similar to those shown in FIGS. 3A through 3C, a similar relationship should be defined between the input cable 6 and the output cable 7 such as those described in relation to the first and second embodiments. A cable 10 for connecting the high-frequency filter 9 to the amplifier 5 has no relation with heat penetration from the outside of the thermally insulated container 3, and therefore it need not be thermally insulated. It is effective to use a coaxial cable with low electrical transmission loss as the cable 10.

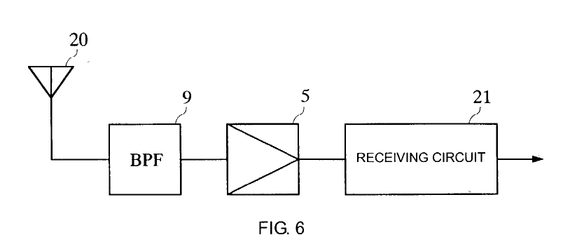

The structure of a communication apparatus according to an aspect of the present invention is described below with reference to FIG. 6.

In FIG. 6, the communication apparatus includes a reception antenna 20, a high-frequency filter 9, an amplifier 5, and a receiving circuit 21. The high-frequency filter 9 permits predetermined reception frequency band components of the signal received by the antenna 20 to pass therethrough, and the amplifier 5 amplifies the passed components with reduced noise. The receiving circuit 21 demodulates the received signal which is amplified to a predetermined gain, and passes the demodulated signal to the subsequent signal processor.

The high-frequency filter 9 and the amplifier 5 shown in FIG. 6 are preferably formed by a low-temperature high-frequency amplifying apparatus similar to that shown in FIG. 5.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A low-temperature high-frequency amplifying apparatus comprising:
an amplifying circuit;
a cooling unit for cooling the amplifying circuit; and
a thermally insulated container which accommodates at least the amplifying circuit and the cooling unit;
wherein the thermally insulated container has an input connector exposed to the outside of the container, the input connector being connected with an input portion of the amplifying circuit via an input high-frequency line;
the thermally insulated container has an output connector exposed to the outside of the container, the output connector being connected with an output portion of the amplifying circuit via an output high-frequency line;
the signal transmission loss of the input high-frequency line is lower than the signal transmission loss of the output high-frequency line; and
the amount of heat penetration from the output high-frequency line to the amplifying circuit is less than the amount of heat penetration from the input high-frequency line to the amplifying circuit.

2. The low-temperature high-frequency amplifying apparatus according to claim 1, wherein the input high-frequency line is shorter than the output high-frequency line.

3. The low-temperature high-frequency amplifying apparatus according to claim 2, wherein the distance from the input portion of the amplifying circuit to a wall of the thermally insulated container is substantially equal to the distance from the output portion of the amplifying circuit to the wall of the thermally insulated container.

4. The low-temperature high-frequency amplifying apparatus according to claim 1, wherein the input high-frequency line has a greater cross-sectional area than the output high-frequency line.

5. The low-temperature high-frequency amplifying apparatus according to claim 1, wherein the amplifying circuit includes an amplifier and a high-frequency filter which is connected to one of an input side and an output side of the amplifier.

6. The low-temperature high-frequency amplifying apparatus according to claim 5, wherein the high-frequency filter comprises a superconductive filter having an electrode made of a superconductor.

7. A wireless apparatus comprising an amplifying portion for amplifying a high-frequency signal, wherein said amplifying portion includes the low-temperature high-frequency amplifying apparatus according to claim 1.
